(19) United States
(12) Patent Application Publication
(10) Pub. No.: US 2022/0312500 A1
(43) Pub. Date: Sep. 29, 2022

(54) PHASE TRACKING REFERENCE SIGNAL CONFIGURATION FOR A RANDOM ACCESS PROCEDURE

(71) Applicant: QUALCOMM Incorporated, San Diego, CA (US)

(72) Inventors: Yiqing CAO, Beijing (CN); Xiao Feng WANG, San Diego, CA (US); Wanshi CHEN, San Diego, CA (US); Jing LEI, San Diego, CA (US); Huilin XU, Temecula, CA (US); Peter GAAL, San Diego, CA (US); Juan MONTOJO, San Diego, CA (US); Yan LI, Beijing (CN); Bin HAN, Beijing (CN)

(21) Appl. No.: 17/594,847

(22) PCT Filed: Apr. 28, 2020
(86) PCT No.: PCT/CN2020/087384

§ 371 Date: Nov. 1, 2021

(30) Foreign Application Priority Data
May 27, 2019 (CN) PCT/CN2019/088481

(51) Int. Cl. H04W 74/08; H04W 72/04; H04L 5/00; H04L 1/00

(52) U.S. Cl. CPC H04W 74/0841; H04W 74/0866; H04W 72/0446; H04W 72/0453; H04L 5/0051; H04L 1/0003

(57) ABSTRACT

Various aspects of the present disclosure generally relate to wireless communication. In some aspects, a user equipment (UE) may receive a phase tracking reference signal (PTRS) configuration for a random access channel (RACH) procedure, wherein the PTRS configuration indicates a PTRS density per modulation and coding scheme (MCS). The UE may perform the RACH procedure according to the PTRS configuration and an MCS used for the RACH procedure. Numerous other aspects are provided.

### CROSS-REFERENCE TO RELATED APPLICATION

This patent application claims priority to Patent Cooperation Treaty (PCT) Application No. PCT/CN2019/088481, filed on May 27, 2019, entitled “PHASE TRACKING REFERENCE SIGNAL CONFIGURATION FOR A RANDOM ACCESS PROCEDURE,” and assigned to the assignee hereof. The disclosure of the prior application is considered part of and is incorporated by reference in this patent application.

### FIELD OF THE DISCLOSURE

Aspects of the present disclosure generally relate to wireless communication and to techniques and apparatuses for phase tracking reference signal configuration for a random access procedure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include receiving a phase tracking reference signal (PTRS) configuration for a random access channel (RACH) procedure, wherein the PTRS configuration indicates a PTRS density per modulation and coding scheme (MCS); and performing the RACH procedure according to the PTRS configuration and an MCS used for the RACH procedure.

In some aspects, a UE for wireless communication may include memory and one or more processors operatively coupled to the memory. The memory and the one or more processors may be configured to receive a PTRS configuration for a RACH procedure, wherein the PTRS configuration indicates a PTRS density per MCS; and perform the RACH procedure according to the PTRS configuration and an MCS used for the RACH procedure.

In some aspects, a non-transitory computer-readable medium may store one or more instructions for wireless communication. The one or more instructions, when executed by one or more processors of a UE, may cause the one or more processors to: receive a PTRS configuration for a RACH procedure, wherein the PTRS configuration indicates a PTRS density per MCS; and perform the RACH procedure according to the PTRS configuration and an MCS used for the RACH procedure.

In some aspects, an apparatus for wireless communication may include means for receiving a PTRS configuration for a RACH procedure, wherein the PTRS configuration indicates a PTRS density per MCS; and means for performing the RACH procedure according to the PTRS configuration and an MCS used for the RACH procedure.

In some aspects, a method of wireless communication, performed by a base station, may include transmitting a PTRS configuration for a RACH procedure, wherein the PTRS configuration indicates a PTRS density per MCS; and performing the RACH procedure according to the PTRS configuration and an MCS used for the RACH procedure.

In some aspects, a base station for wireless communication may include memory and one or more processors operatively coupled to the memory. The memory and the one or more processors may be configured to transmit a PTRS configuration for a RACH procedure, wherein the PTRS configuration indicates a PTRS density per MCS; and perform the RACH procedure according to the PTRS configuration and an MCS used for the RACH procedure.

In some aspects, a non-transitory computer-readable medium may store one or more instructions for wireless communication. The one or more instructions, when executed by one or more processors of a base station, may cause the one or more processors to: transmit a PTRS configuration for a RACH procedure, wherein the PTRS configuration indicates a PTRS density per MCS; and perform the RACH procedure according to the PTRS configuration and an MCS used for the RACH procedure.

In some aspects, an apparatus for wireless communication may include means for transmitting a PTRS configuration for a RACH procedure, wherein the PTRS configuration indicates a PTRS density per MCS; and means for performing the RACH procedure according to the PTRS configuration and an MCS used for the RACH procedure.

Aspects generally include a method, apparatus, system, computer program product, non-transitory computer-readable medium, user equipment, base station, wireless communication device, and processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIGS. 3-5 are diagrams illustrating examples of phase tracking reference signal configuration for a random access procedure, in accordance with various aspects of the present disclosure.

FIG. 6 is a diagram illustrating an example process performed, for example, by a user equipment, in accordance with various aspects of the present disclosure.

FIG. 7 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

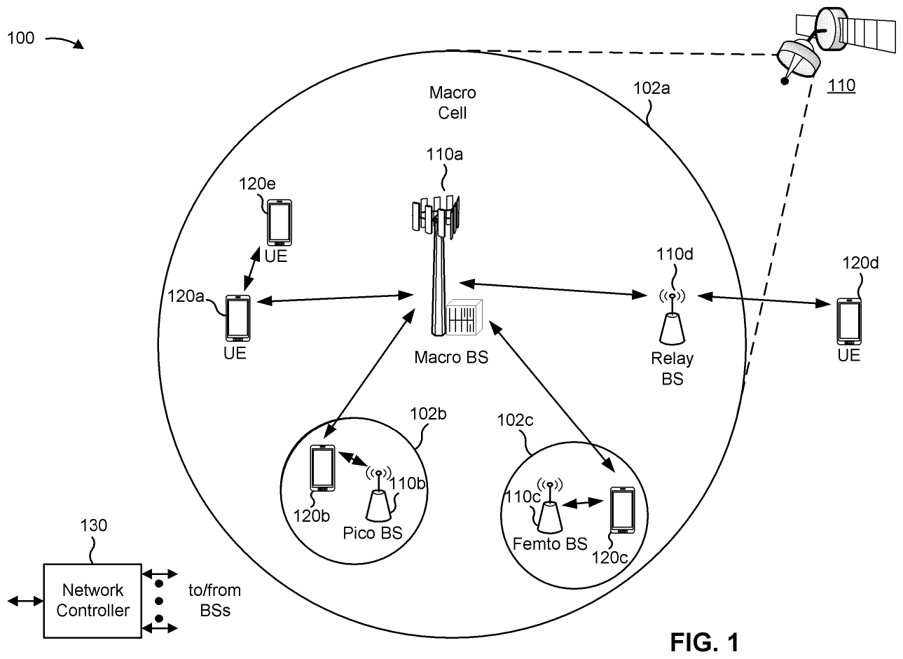

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

In some examples, a cell may be provided by a base station 110 of a non-terrestrial network, also referred to as a non-terrestrial base station 110 or a non-terrestrial access point. As used herein, a non-terrestrial network may refer to a network for which access is provided by a non-terrestrial base station 110. In some aspects, a non-terrestrial base station 110 may be located on an airborne vehicle or a vehicle in orbit, such as a satellite, a balloon, a dirigible, an airplane, an unmanned aerial vehicle, a drone, or the like. Additionally or alternatively, a non-terrestrial base station 110 may act as a relay station to relay communications between a UE 120 and a terrestrial base station 110 (such as a base station 110 located on the ground), as described below. In some aspects, a UE 120 may be a ground station (GS).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

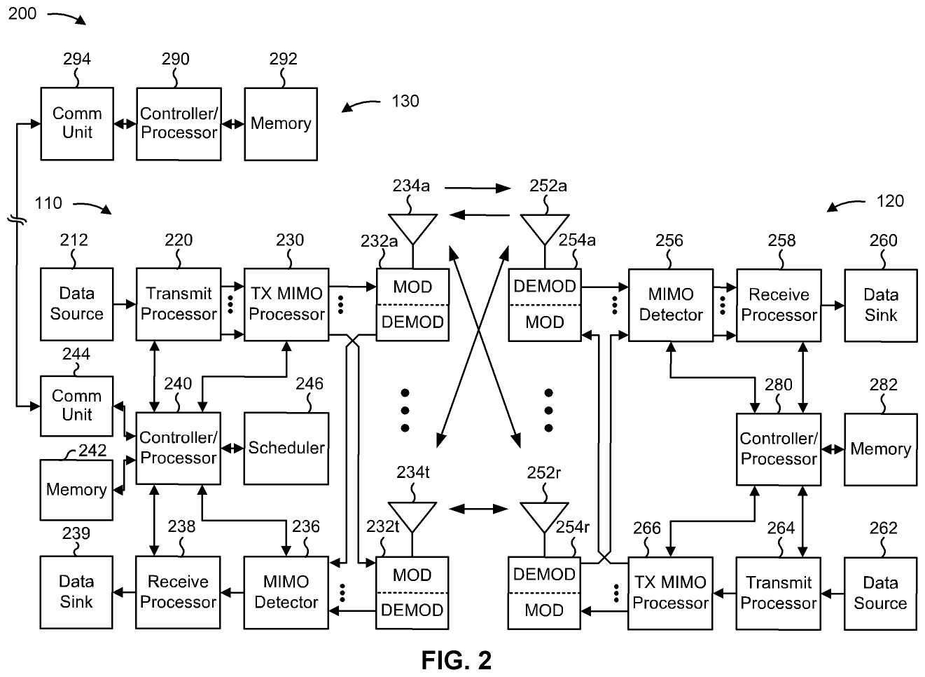

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

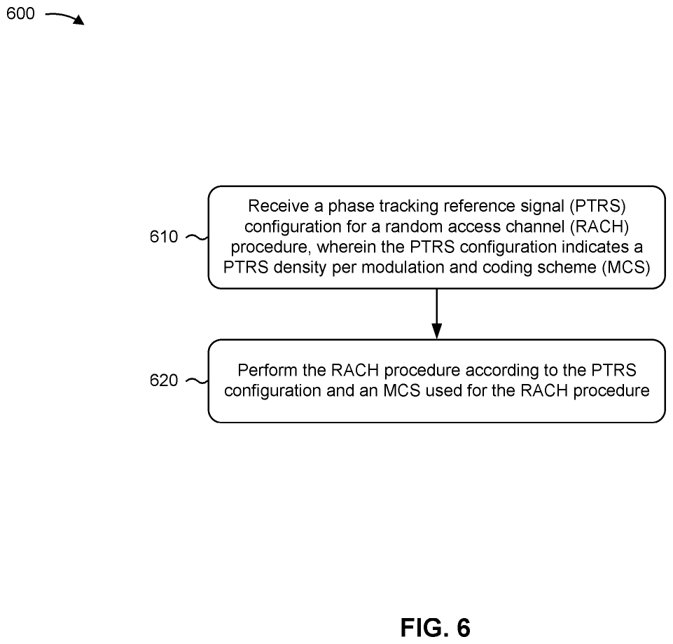

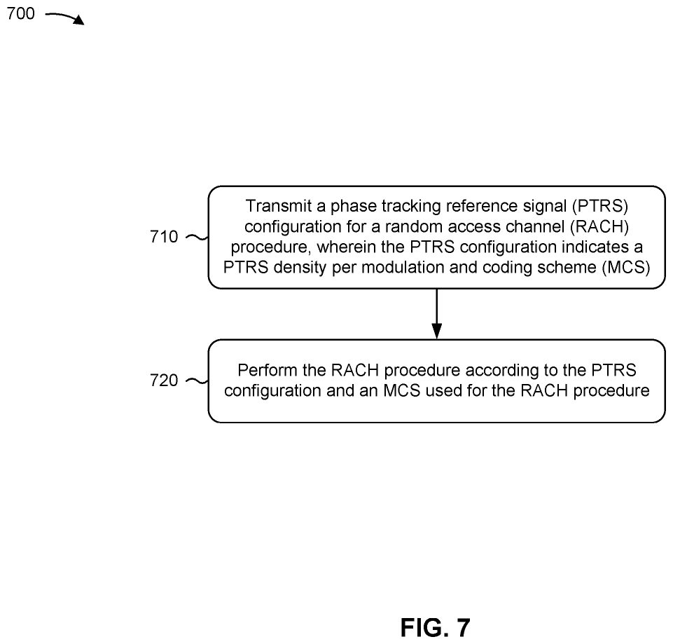

Controller/processor 240 of base station 110, controller/processor 280 of UE 120, and/or any other component(s) of FIG. 2 may perform one or more techniques associated with phase tracking reference signal configuration for a random access procedure, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, and/or other processes as described herein. Memories 242 and 282 may store data and program codes for base station 110 and UE 120, respectively. A scheduler 246 may schedule UEs for data transmission on the downlink and/or uplink.

In some aspects, UE 120 may include means for receiving a PTRS configuration for a RACH procedure, wherein the PTRS configuration indicates a PTRS density per MCS; means for performing the RACH procedure according to the PTRS configuration and an MCS used for the RACH procedure; and/or the like. In some aspects, such means may include one or more components of UE 120 described in connection with FIG. 2.

In some aspects, base station 110 may include means for transmitting a PTRS configuration for a RACH procedure, wherein the PTRS configuration indicates a PTRS density per MCS; means for performing the RACH procedure according to the PTRS configuration and an MCS used for the RACH procedure; and/or the like. In some aspects, such means may include one or more components of base station 110 described in connection with FIG. 2.

As indicated above, FIG. 2 is provided as an example. Other examples may differ from what is described with regard to FIG. 2.

In NR, a phase tracking reference signal (PTRS) was introduced to compensate for phase noise in a transmitted signal, particularly a signal transmitted using a millimeter wave frequency. In a transmitter, the phase noise increases as the operating frequency increases. Phase noise is generated by a local oscillator in the transmitter, and may introduce constant or common phase error (CPE) or other phase noise errors into the transmitted signal, which degrades demodulation performance. The PTRS may be used to track phase noise in a local oscillator (e.g., in a transmitter and/or a receiver) and to suppress such phase noise, especially at millimeter wave frequencies.

In NR, PTRS may be present in and transmitted in a downlink data channel (e.g., a physical downlink shared channel (PDSCH)) and an uplink data channel (e.g., a physical uplink shared channel (PUSCH)). Such PTRS may be configured in downlink control information (DCI). Because PDSCH and PUSCH communications may be transmitted with high modulation and coding schemes (MCSs), which are more susceptible to degraded demodulation due to phase noise, the PTRS may be transmitted in the PDSCH and the PUSCH. For random access channel (RACH) communications, transmitted as part of an initial network access procedure, a lower or fixed MCS may be used, making RACH communications more robust against phase noise. Thus, to reduce signaling overhead, PTRS may not be transmitted in the RACH as part of a RACH procedure.

However, some NR deployments may be subject to a large Doppler shift due to a high relative speed between a base station 110 and a UE 120, such as a non-terrestrial network (NTN) deployment that uses a non-stationary satellite as a base station 110 (e.g., a low Earth orbit (LEO) satellite, a middle Earth orbit (MEO) satellite, and/or the like). This large Doppler shift increases the difficulty of channel estimation due to a frequency offset and/or a timing offset resulting from the large Doppler shift. Some techniques and apparatuses described herein introduce one or more PTRSs into a RACH procedure (e.g., for one or more messages of the RACH procedure, such as Msg1, Msg2, Msg3, Msg4, MsgA, MsgB, and/or the like) to assist with channel estimation and phase noise correction in such deployments. In this way, demodulation performance may be improved for the RACH procedure, thereby reducing latency, increasing reliability, and improving network performance.

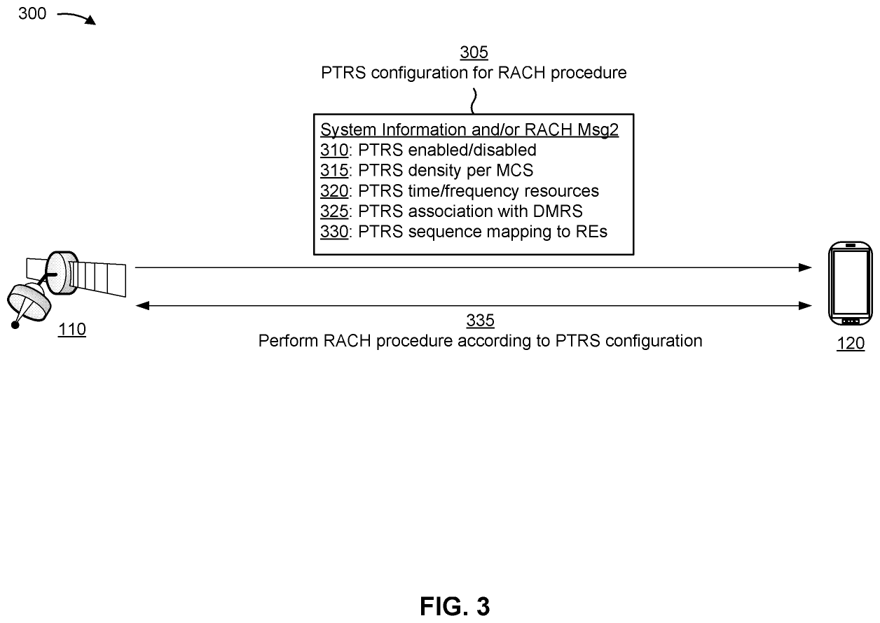

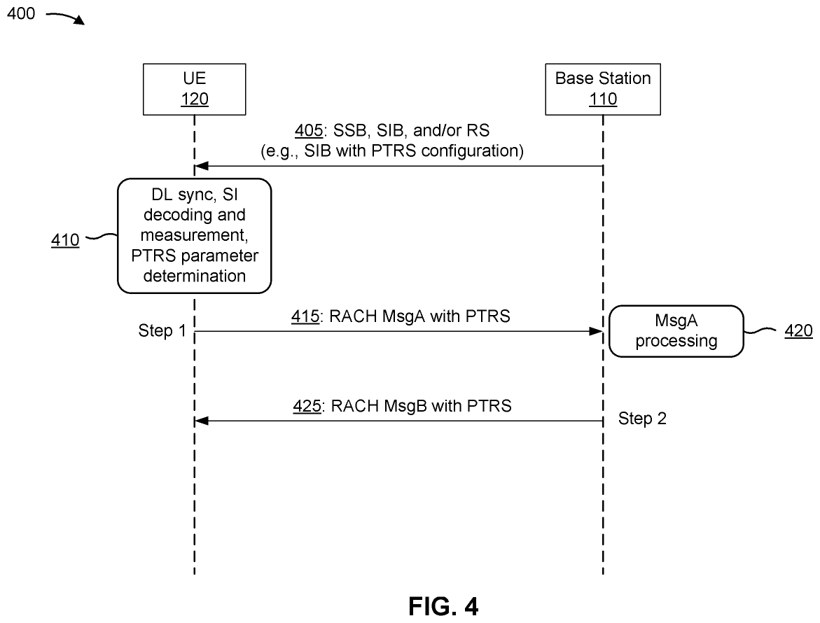

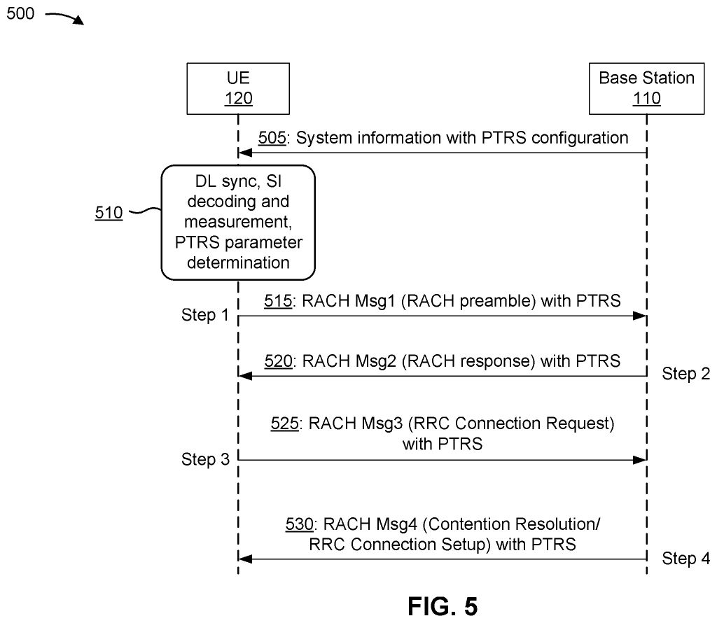

FIG. 3 is a diagram illustrating an example 300 of phase tracking reference signal configuration for a random access procedure, in accordance with various aspects of the present disclosure. As shown in FIG. 3, a base station 110 and a UE 120 may communicate with one another to perform a RACH procedure, such as a two-step RACH procedure (described in more detail in connection with FIG. 4) or a four-step RACH procedure (described in more detail in connection with FIG. 5). Although base station 110 is shown as a satellite, in some aspects, base station 110 may be another type of non-terrestrial network base station 110 or may be a terrestrial base station 110.

As shown by reference number 305, the base station 110 may transmit, and the UE 120 may receive, a phase tracking reference signal (PTRS) configuration for a random access channel (RACH) procedure. The PTRS configuration may include one or more PTRS parameters for configuring one or more PTRSs for the RACH procedure. For example, as shown, a PTRS parameter may include an indication of whether PTRS is enabled or disabled for the RACH procedure, a PTRS density per modulation and coding scheme (MCS) and/or per bandwidth, time and/or frequency resources configured for transmission and/or reception of PTRSs, an association between PTRSs and demodulation reference signals (DMRSs), a mapping of PTRSs to resource elements (REs), and/or the like. In some aspects, a PTRS configuration may apply to multiple RACH messages. As used herein, a RACH message may refer to RACH Msg1, RACH Msg2, RACH Msg3, RACH Msg4, RACH MsgA, RACH MsgB, and/or the like. For example, RACH Msg1 and RACH Msg3 may have the same PTRS configuration (e.g., or one or more PTRS parameters of the PTRS configuration may be the same). Additionally, or alternatively, RACH Msg2 and RACH Msg4 may have the same PTRS configuration (e.g., or one or more PTRS parameters of the PTRS configuration may be the same). Alternatively, different RACH messages may have different PTRS configurations.

In some aspects, the PTRS configuration may be indicated in system information. For example, the PTRS configuration may be transmitted and/or received in a physical broadcast channel (PBCH) communication (e.g., a synchronization signal/PBCH (SS/PBCH) block and/or the like), remaining minimum system information (RMSI), other system information (OSI), and/or the like. In this way, the UE 120 can receive the PTRS configuration for the RACH procedure prior to performing the RACH procedure. Additionally, or alternatively, the PTRS configuration (or a portion of the PTRS configuration, such as one or more PTRS parameters that differ from a PTRS configuration indicated in system information) may be indicated in a first RACH message that schedules and/or carries control information for a second RACH message. For example, all or a portion of the PTRS configuration for RACH Msg3 may be included in RACH Msg2, as described in more detail in connection with FIG. 5.

As shown by reference number 310, in some aspects, the PTRS configuration may indicate whether PTRSs are enabled or disabled for the RACH procedure. For example, the indication may be a single bit. A first value of the bit (e.g., 0) may indicate that PTRSs are disabled for the RACH procedure, and a second value of the bit (e.g., 1) may indicate that PTRSs are enabled for the RACH procedure.

As shown by reference number 315, in some aspects, the PTRS configuration may indicate a PTRS density per MCS. For example, the PTRS configuration may indicate a time density for PTRSs (e.g., a time periodicity for PTRSs). In some aspects, the base station 110 may determine the time density based at least in part on an MCS to be used for the RACH procedure. In some aspects, different RACH messages may be associated with different MCSs. As a result, different RACH messages may be associated with different PTRS time densities. In some aspects, the base station 110 may determine the PTRS density using a table. For example, the base station 110 may determine the PTRS time density using a table that maps a set of MCSs (or a set of MCS ranges) to a corresponding set of PTRS time densities. Additionally, or alternatively, the base station 110 may indicate the table to the UE 120 (e.g., in system information), and the UE 120 may determine the PTRS time density using the table (e.g., based at least in part on an MCS used by the UE 120 for the RACH procedure and/or a RACH message).

Additionally, or alternatively, the PTRS configuration may indicate a frequency density for PTRSs (e.g., a resource block (RB) periodicity and/or pattern for PTRSs, a sub-carrier periodicity and/or pattern for PTRSs, and/or the like). In some aspects, the base station 110 may determine the frequency density based at least in part on a bandwidth for the RACH. In some aspects, the RACH may have a fixed bandwidth. In this case, different RACH messages may be associated with the same PTRS frequency density. In some aspects, the base station 110 may determine the PTRS density using a table. For example, the base station 110 may determine the PTRS frequency density using a table that maps a set of bandwidths (or a set of bandwidth ranges) to a corresponding set of PTRS frequency densities. Additionally, or alternatively, the base station 110 may indicate the table to the UE 120 (e.g., in system information), and the UE 120 may determine the PTRS frequency density using the table (e.g., based at least in part on a bandwidth used by the UE 120 for the RACH procedure and/or a RACH message).

As shown by reference number 320, in some aspects, the PTRS configuration may indicate a set of time domain resources and/or a set of frequency domain resources for PTRS transmission. In some aspects, the set of time domain resources and/or the set of frequency domain resources may be indicated based at least in part on the time density and/or frequency density for PTRSs, as indicated above. Additionally, or alternatively, the PTRS configuration may indicate a starting symbol and an ending symbol for the set of time domain resources, a starting frequency and an ending frequency for the set of frequency domain resources, a PTRS time domain resource pattern for the set of time domain resources (e.g., that indicates the symbols in which PTRS is to be transmitted), a PTRS frequency domain resource pattern for the set of frequency domain resources (e.g., that indicates the sub-carriers or RBs in which the PTRS is to be transmitted), a joint PTRS resource pattern for both the set of time domain resources and the set of frequency domain resources (e.g., that indicates the symbols and the sub-carriers or RBs in which the PTRS is to be transmitted), and/or the like.

In some aspects, in the time domain, PTRSs are allocated on every symbol and/or on every symbol for which DMRS is not allocated. In some aspects, in the frequency domain, PTRSs are allocated every k resource blocks (e.g., k=1, 2, 4, and/or the like). In some aspects, a frequency density of PTRS may be higher for a higher MCS, and may be lower for a lower MCS. In some aspects, the PTRS configuration may indicate one or more zero power (ZP) PTRSs for one or more time domain resources and/or one or more frequency domain resources. In this case, the PTRS(s) may be blanked in those resource(s), such as for transmission of DMRS and/or data (e.g., using rate matching).

In some aspects, the PTRS configuration may indicate a PTRS resource pattern (e.g., a PTRS time domain resource pattern, a PTRS frequency domain resource pattern, a joint PTRS resource pattern for both time domain resources and frequency domain resources, and/or the like) selected from a set of PTRS resource patterns. For example, the base station 110 may determine the PTRS resource pattern based at least in part on an MCS and/or a bandwidth to be used for the RACH procedure, in a similar manner as described above. In some aspects, the base station 110 may determine the PTRS resource pattern using a table. For example, the base station 110 may determine the PTRS resource pattern using a table that maps a set of MCSs (or a set of MCS ranges) and/or a set of bandwidths (or a set of bandwidth ranges) to a corresponding set of PTRS resource patterns. Additionally, or alternatively, the base station 110 may indicate the table to the UE 120 (e.g., in system information), and the UE 120 may determine the PTRS resource pattern using the table (e.g., based at least in part on an MCS and/or a bandwidth used by the UE 120 for the RACH procedure and/or a RACH message).

As shown by reference number 325, in some aspects, the PTRS configuration may indicate an association between the PTRS configuration and one or more DMRS configurations. For example, in some aspects, the PTRS configuration (e.g., for the RACH procedure and/or a RACH message) may depend on a DMRS configuration (e.g., for the RACH procedure and/or the RACH message). For example, the PTRS configuration may depend on a downlink DMRS configuration, an uplink DMRS configuration, or both the downlink DMRS configuration and the uplink DMRS configuration. In some aspects, the PTRS configuration may indicate an association between one or more PTRS antenna ports and one or more DMRS antenna ports. In some aspects, the PTRS configuration for a RACH message (e.g., Msg1, Msg2, Msg3, Msg4, MsgA, MsgB, and/or the like) may depend on a DMRS configuration for that RACH message (e.g., a downlink DMRS configuration for that RACH message, an uplink DMRS configuration for that RACH message, or both the downlink DMRS configuration and the uplink DMRS configuration for that RACH message). Alternatively, the PTRS configuration may be independent of a DMRS configuration.

For example, the base station 110 may indicate a DMRS configuration to the UE 120 and may indicate an association between the DMRS configuration and the PTRS configuration. In this case, the UE 120 may determine the PTRS configuration based at least in part on the DMRS configuration. For example, because DMRSs can be used for phase tracking, the DMRS configuration may indicate the symbols and/or frequencies in which PTRSs are to be transmitted. For example, the PTRS may be configured and/or scheduled for transmission in symbols and/or frequencies in which a DMRS is not configured and/or scheduled for transmission.

As shown by reference number 330, the PTRS configuration may indicate a mapping between PTRS sequences and resource elements. For example, the PTRS configuration may indicate whether PTRS sequences are mapped to resource elements in a sequence-first, time-second manner or in a time-first, sequence-second manner. This mapping may be used by a receiver (e.g., the base station 110 and/or the UE 120) when performing blind decoding of PTRS sequences in a resource element to conserve processing resources by reducing a number of blind decoding operations (e.g., by using a PTRS sequence received in a first resource element (RE) to predict a PTRS sequence in a second RE based at least in part on the mapping).

As shown by reference number 335, the base station 110 and/or the UE 120 may perform the RACH procedure according to the PTRS configuration. For example, the base station 110 and/or the UE 120 may perform the RACH procedure using one or more PTRS parameters indicated in the configuration. In some aspects, performing the RACH procedure may include transmitting a RACH message with one or more PTRSs that depend on the PTRS configuration, monitoring for and/or receiving a RACH message with one or more PTRSs that depend on the PTRS configuration, and/or the like. Additionally, or alternatively, performing the RACH procedure may include correcting and/or compensating for phase noise in a RACH message using one or more PTRSs received in association with the RACH message.

In some aspects, performing the RACH procedure may include transmitting (or monitoring for) or refraining from transmitting (or refraining from monitoring for) one or more PTRSs in association with a RACH message based at least in part on an indication, in the PTRS configuration, of whether PTRS transmission is enabled or disabled for the RACH procedure. Additionally, or alternatively, performing the RACH procedure may include transmitting (or monitoring for) one or more PTRSs in the RACH based at least in part on a PTRS density indicated in the PTRS configuration. Additionally, or alternatively, performing the RACH procedure may include transmitting (or monitoring for) one or more PTRSs in one or more time resources and/or one or more frequency resources indicated in the PTRS configuration. Additionally, or alternatively, performing the RACH procedure may include transmitting (or monitoring for) one or more PTRSs according to an association between PTRSs and DMRSs indicated in the PTRS configuration. Additionally, or alternatively, performing the RACH procedure may include transmitting (or monitoring for) one or more PTRS sequences according to a mapping of PTRSs to REs as indicated in the PTRS configuration.

In some aspects, performing the RACH procedure may include transmitting and/or receiving an initial RACH transmission and a RACH retransmission, such as when an acknowledgement (ACK) is not received for the initial RACH transmission or a negative acknowledgement (NACK) is received for the initial RACH transmission. In some aspects, a same PTRS configuration (e.g., a same set of PTRS parameters) may be used for the initial transmission of a RACH message and a retransmission of that RACH message. Alternatively, a different PTRS configuration (e.g., a different set of PTRS parameters) may be used for the initial transmission of a RACH message and a retransmission of that RACH message. In some aspects, the PTRS configuration may indicate whether a same PTRS configuration or a different PTRS configuration is to be used for initial RACH transmissions and RACH retransmissions. If a different PTRS configuration is used for RACH retransmissions, the PTRS configuration may indicate one or more PTRS parameters that differ between initial RACH transmissions and RACH retransmissions.

For example, an initial RACH transmission may use a first set of resources for PTRS transmission and a RACH retransmission may use a second set of resources (e.g., that is different from the first set) for PTRS transmission. In this case, the PTRS configuration may indicate the first set of resources and the second set of resources. For example, the PTRS configuration may indicate a set of PTRS resource patterns. A first PTRS resource pattern in the set may be used for an initial RACH transmission and a second PTRS resource pattern in the set may be used for RACH retransmissions.

In some aspects, to protect against phase noise, the RACH procedure may be performed using a highest possible sub-carrier spacing supported by a UE capability and supported by an uplink bandwidth part used for the RACH (e.g., for RACH communications from the UE 120 to the base station 110). Thus, techniques and apparatuses described herein may assist with compensating for phase noise during a RACH procedure, particularly for scenarios with a large Doppler shift, such as non-terrestrial network deployments.

As indicated above, FIG. 3 is provided as an example. Other examples may differ from what is described with respect to FIG. 3.

FIG. 4 is a diagram illustrating another example 400 of phase tracking reference signal configuration for a random access procedure, in accordance with various aspects of the present disclosure. FIG. 4 shows an example RACH procedure that may be performed according to a PTRS configuration. The RACH procedure shown in FIG. 4 is a two-step RACH procedure. As shown in FIG. 4, a base station 110 and a UE 120 may communicate with one another to perform the two-step RACH procedure.

In a first operation 405, the base station 110 may transmit and the UE 120 may receive one or more synchronization signal blocks (SSBs), system information (e.g., in one or more system information blocks (SIBs)), reference signals (RSs), and/or the like. The system information may include a PTRS configuration, as described above.

In a second operation 410, the UE 120 may perform downlink (DL) synchronization (such as by using one or more SSBs), may decode system information (SI) that is included in one or more SIBs, and/or may perform one or more measurements of the RS(s). Based at least in part on performing the second operation 410, the UE 120 may determine parameters for transmitting a RACH message in the two-step RACH procedure. For example, the UE 120 may determine one or more PTRS parameters to be used to transmit the RACH message.

In a third operation 415, the UE 120 may transmit RACH MsgA, which may include, for example, a RACH preamble and a RACH payload. In some aspects, RACH MsgA may include some or all of the contents of RACH Msg1 and RACH Msg3 of a four-step RACH procedure. For example, RACH MsgA may include some or all contents of RACH Msg1, such as a RACH preamble, and may include some or all contents of RACH Msg3, such as a UE identifier, uplink control information, and/or the like. As shown, the UE 120 may transmit RACH MsgA as part of a first step of the two-step RACH procedure. In some aspects, RACH MsgA may be transmitted with one or more PTRSs (e.g., in one or more symbols of RACH MsgA) according to the PTRS configuration. In some aspects, the UE 120 may generate a RACH preamble for RACH MsgA using a Gold sequence (e.g., rather than a Zadoff-Chu sequence) to assist with phase noise compensation.

In some aspects, the UE 120 may generate a PTRS for RACH MsgA using a Gold sequence and a scrambling identifier. The scrambling identifier may be generated based at least in part on a radio network temporary identifier (RNTI) associated with the UE, a DMRS port number associated with the UE, and/or a preamble identifier indicated in the RACH MsgA. For example, the scrambling identifier may be determined by:

Scrambling ID=RA-RNTI+M×DMRS Port Number+N×Preamble ID

In the above equation, RA-RNTI is a random access RNTI, M is a non-negative integer (e.g., zero or a positive integer) used as a first coefficient for the DMRS port number, and N is a non-negative integer (e.g., zero or a positive integer) used as a second coefficient for the preamble identifier. Because the UE 120 may not yet have a UE-specific identifier to be used to scramble RACH MsgA for contention resolution, one or more of the above terms may be used to determine a scrambling identifier to assist with contention resolution.

In a fourth operation 420, the base station 110 may process RACH MsgA. For example, the base station 110 may receive a RACH preamble included in RACH MsgA. If the base station 110 successfully receives and decodes the RACH preamble, the base station 110 may then receive and decode a RACH payload included in RACH MsgA.

In a fifth operation 425, the base station 110 may transmit RACH MsgB. As shown, the base station 110 may transmit RACH MsgB as part of a second step of the two-step RACH procedure. In some aspects, RACH MsgB may include some or all of the contents of RACH Msg2 and RACH Msg4 of a four-step RACH procedure. For example, RACH MsgB may include the detected RACH preamble identifier, the detected UE identifier, a timing advance value, contention resolution information, and/or the like. In some aspects, RACH MsgB may be transmitted with one or more PTRSs (e.g., in one or more symbols of RACH MsgB) according to the PTRS configuration.

In some aspects, the base station 110 may scramble a PTRS for RACH MsgB using a scrambling identifier. The scrambling identifier may be generated based at least in part on an RNTI associated with the UE, a random access preamble identifier (RAPID) associated with the UE, or another UE-specific identifier. In this way, the scrambling identifier may assist with contention resolution.

By using PTRSs in the two-step RACH procedure, techniques and apparatuses described herein may assist with compensating for phase noise during the two-step RACH procedure, particularly for scenarios with a large Doppler shift, such as non-terrestrial network deployments. In this way, demodulation performance may be improved for the RACH procedure, thereby reducing latency, increasing reliability, reducing an amount of time required for initial network access, and improving network performance.

As indicated above, FIG. 4 is provided as an example. Other examples may differ from what is described with respect to FIG. 4.

FIG. 5 is a diagram illustrating another example 500 of phase tracking reference signal configuration for a random access procedure, in accordance with various aspects of the present disclosure. FIG. 5 shows an example RACH procedure that may be performed according to a PTRS configuration. The RACH procedure shown in FIG. 5 is a four-step RACH procedure. As shown in FIG. 5, a base station 110 and a UE 120 may communicate with one another to perform the four-step RACH procedure.

In a first operation 505, the base station 110 may transmit, and the UE 120 may receive, one or more SSBs, system information (e.g., in one or more SIBs), and/or RSs. The system information may include a PTRS configuration, as described above.

In a second operation 510, the UE 120 may perform DL synchronization, may decode SI that is included in one or more SIBs, and/or may perform one or more measurements of the RS(s). Based at least in part on performing the second operation 510, the UE 120 may determine parameters for transmitting a RACH message in the four-step RACH procedure. For example, the UE 120 may determine one or more PTRS parameters to be used to transmit the RACH message.

In a third operation 515, the UE 120 may transmit RACH Msg1, which may include, for example, a RACH preamble. As shown, the UE 120 may transmit RACH Msg1 as part of a first step of the four-step RACH procedure. In some aspects, RACH Msg1 may be transmitted with one or more PTRSs (e.g., in one or more symbols of RACH Msg1) according to the PTRS configuration. In some aspects, the UE 120 may generate a RACH preamble for RACH Msg1 using a Gold sequence (e.g., rather than a Zadoff-Chu sequence) to assist with phase noise compensation.

In a fourth operation 520, the base station 110 may transmit RACH Msg2, which may be referred to as a RACH response or a random access response. RACH Msg2 may include, for example, an indication of the detected RACH preamble identifier (e.g., RAPID) and a resource allocation for RACH Msg3. As shown, the base station 110 may transmit RACH Msg2 as part of a second step of the four-step RACH procedure. In some aspects, RACH Msg2 may be transmitted with one or more PTRSs (e.g., in one or more symbols of RACH Msg2) according to the PTRS configuration. In some aspects, RACH Msg2 may indicate a PTRS configuration for RACH Msg3 (e.g., in an RRC message and/or DCI of RACH Msg2). For example, RACH Msg2 may indicate one or more PTRS parameters to be used for RACH Msg3. In some aspects, RACH Msg2 may indicate only those PTRS parameters that differ from a PTRS configuration indicated in system information, thereby reducing signaling overhead.

In a fifth operation 525, the UE 120 may transmit RACH Msg3. RACH Msg3 may include, for example, a RACH payload, a radio resource control (RRC) connection request, a UE identifier, uplink control information, and/or the like. As shown, the UE 120 may transmit RACH Msg3 as part of a third step of the four-step RACH procedure. In some aspects, RACH Msg3 may be transmitted with one or more PTRSs (e.g., in one or more symbols of RACH Msg3) according to a PTRS configuration indicated in system information and/or a PTRS configuration indicated in RACH Msg2. In some aspects, PTRS parameter(s) indicated in RACH Msg2 may override corresponding PTRS parameter(s) indicated in system information. In some aspects, if a value of a PTRS parameter is indicated in RACH Msg2, then the UE 120 may use that value for the PTRS parameter for RACH Msg3 (e.g., rather than a value indicated in a PTRS configuration indicated in system information). Conversely, if a value of a PTRS parameter is not indicated in RACH Msg2, then the UE 120 may use a value for that PTRS parameter from a PTRS configuration indicated in system information.

In some aspects, the UE 120 may scramble RACH Msg3 using a scrambling identifier. The scrambling identifier may be generated based at least in part on a temporary cell radio network temporary identifier (TC-RNTI), a random access radio network temporary identifier (RA-RNTI), or another type of RNTI. In this way, the scrambling identifier may assist with contention resolution.

In a sixth operation 530, the base station 110 may transmit RACH Msg4. RACH Msg4 may include, for example, a timing advance value, contention resolution information, an RRC connection setup message, and/or the like. As shown, the base station 110 may transmit RACH Msg4 as part of a fourth step of the four-step RACH procedure. In some aspects, RACH Msg4 may be transmitted with one or more PTRSs (e.g., in one or more symbols of RACH Msg4) according to the PTRS configuration.

By using PTRSs in the four-step RACH procedure, techniques and apparatuses described herein may assist with compensating for phase noise during the four-step RACH procedure, particularly for scenarios with a large Doppler shift, such as non-terrestrial network deployments. In this way, demodulation performance may be improved for the RACH procedure, thereby reducing latency, increasing reliability, reducing an amount of time required for initial network access, and improving network performance.

As indicated above, FIG. 5 is provided as an example. Other examples may differ from what is described with respect to FIG. 5.

FIG. 6 is a diagram illustrating an example process 600 performed, for example, by a UE, in accordance with various aspects of the present disclosure. Example process 600 is an example where a UE (e.g., UE 120 and/or the like) performs operations associated with phase tracking reference signal configuration for a random access procedure.

As shown in FIG. 6, in some aspects, process 600 may include receiving a PTRS configuration for a RACH procedure, wherein the PTRS configuration indicates a PTRS density per MCS (block 610). For example, the UE (e.g., using receive processor 258, controller/processor 280, memory 282, and/or the like) may receive a PTRS configuration for a RACH procedure, as described above. In some aspects, the PTRS configuration indicates a PTRS density per MCS.

As further shown in FIG. 6, in some aspects, process 600 may include performing the RACH procedure according to the PTRS configuration and an MCS used for the RACH procedure (block 620). For example, the UE (e.g., using receive processor 258, transmit processor 264, controller/processor 280, memory 282, and/or the like) may perform the RACH procedure according to the PTRS configuration and an MCS used for the RACH procedure, as described above.

Process 600 may include additional aspects, such as any single aspect or any combination of aspects described below and/or in connection with one or more other processes described elsewhere herein.

In a first aspect, the PTRS configuration is included in at least one of system information, a physical broadcast channel communication, remaining system information, other system information, or a combination thereof.

In a second aspect, alone or in combination with the first aspect, the PTRS configuration indicates whether PTRSs are enabled for the RACH procedure.

In a third aspect, alone or in combination with one or more of the first and second aspects, the PTRS configuration indicates at least one of a set of time domain resources or a set of frequency domain resources for PTRS transmission.

In a fourth aspect, alone or in combination with one or more of the first through third aspects, at least one of the set of time domain resources or the set of frequency domain resources are indicated using at least one of: a starting symbol and an ending symbol for the set of time domain resources, a starting frequency and an ending frequency for the set of frequency domain resources, a PTRS time domain resource pattern for the set of time domain resources, a PTRS frequency domain resource pattern for the set of frequency domain resources, a joint PTRS resource pattern for both the set of time domain resources and the set of frequency domain resources, or a combination thereof.

In a fifth aspect, alone or in combination with one or more of the first through fourth aspects, at least one of the set of time domain resources or the set of frequency domain resources are determined by a PTRS resource pattern, selected from multiple PTRS resource patterns corresponding to multiple MCSs, based at least in part on the MCS used for the RACH procedure.

In a sixth aspect, alone or in combination with one or more of the first through fifth aspects, the PTRS configuration depends on one or more demodulation reference signal (DMRS) configurations.

In a seventh aspect, alone or in combination with one or more of the first through sixth aspects, the one or more DMRS configurations include a downlink DMRS configuration, an uplink DMRS configuration, or both the downlink DMRS configuration and the uplink DMRS configuration.

In an eighth aspect, alone or in combination with one or more of the first through seventh aspects, the one or more DMRS configurations include a DMRS configuration corresponding to a RACH message for which the PTRS configuration is being determined.

In a ninth aspect, alone or in combination with one or more of the first through eighth aspects, the PTRS configuration is included in RACH Msg2 that indicates a resource allocation for RACH Msg3.

In a tenth aspect, alone or in combination with one or more of the first through ninth aspects, the RACH Msg3 is scrambled using a temporary cell radio network temporary identifier (TC-RNTI), a random access radio network temporary identifier (RA-RNTI), or another type of radio network temporary identifier.

In an eleventh aspect, alone or in combination with one or more of the first through tenth aspects, performing the RACH procedure comprises transmitting RACH MsgA with a PTRS, wherein the PTRS is generated using a Gold sequence and a scrambling identifier that is based at least in part on at least one of a radio network temporary identifier associated with the UE, a DMRS port number associated with the UE, or a preamble identifier indicated in RACH MsgA.

In a twelfth aspect, alone or in combination with one or more of the first through eleventh aspects, performing the RACH procedure comprises receiving RACH MsgB with a PTRS, wherein the PTRS is scrambled using at least one of a radio network temporary identifier associated with the UE, a random access preamble identifier associated with the UE, or another UE-specific identifier.

In a thirteenth aspect, alone or in combination with one or more of the first through twelfth aspects, performing the RACH procedure comprises transmitting RACH Msg1 or RACH MsgA with a RACH preamble that is generated using a Gold sequence.

In a fourteenth aspect, alone or in combination with one or more of the first through thirteenth aspects, the PTRS configuration indicates whether PTRS sequences are mapped to resource elements in a sequence-first, time-second manner or in a time-first, sequence-second manner.

In a fifteenth aspect, alone or in combination with one or more of the first through fourteenth aspects, a same PTRS configuration is used for an initial RACH transmission and a RACH retransmission.

In a sixteenth aspect, alone or in combination with one or more of the first through fifteenth aspects, an initial RACH transmission uses a first set of resources for PTRS transmission and a RACH retransmission uses a second set of resources for PTRS transmission that are different from the first set of resources, wherein the first set of resources and the second set of resources are indicated in the PTRS configuration using a set of PTRS resource patterns.

In a seventeenth aspect, alone or in combination with one or more of the first through sixteenth aspects, the RACH procedure is performed using a highest possible sub-carrier spacing supported by a UE capability and an uplink bandwidth part used for the RACH procedure.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with various aspects of the present disclosure. Example process 700 is an example where a base station (e.g., base station 110 and/or the like) performs operations associated with phase tracking reference signal configuration for a random access procedure.

As shown in FIG. 7, in some aspects, process 700 may include transmitting a PTRS configuration for a RACH procedure, wherein the PTRS configuration indicates a PTRS density per MCS (block 710). For example, the base station (e.g., using transmit processor 220, controller/processor 240, memory 242, and/or the like) may transmit a PTRS configuration for a RACH procedure, as described above. In some aspects, the PTRS configuration indicates a PTRS density per MCS.

As further shown in FIG. 7, in some aspects, process 700 may include performing the RACH procedure according to the PTRS configuration and an MCS used for the RACH procedure (block 720). For example, the base station (e.g., using transmit processor 220, receive processor 238, controller/processor 240, memory 242, and/or the like) may perform the RACH procedure according to the PTRS configuration and an MCS used for the RACH procedure, as described above.

Process 700 may include additional aspects, such as any single aspect or any combination of aspects described below and/or in connection with one or more other processes described elsewhere herein.

In a first aspect, the PTRS configuration is transmitted in at least one of system information, a physical broadcast channel communication, remaining system information, other system information, or a combination thereof.

In a second aspect, alone or in combination with the first aspect, the PTRS configuration indicates whether PTRSs are enabled for the RACH procedure.

In a third aspect, alone or in combination with one or more of the first and second aspects, the PTRS configuration indicates at least one of a set of time domain resources or a set of frequency domain resources for PTRS transmission.

In a fourth aspect, alone or in combination with one or more of the first through third aspects, at least one of the set of time domain resources or the set of frequency domain resources are indicated using at least one of: a starting symbol and an ending symbol for the set of time domain resources, a starting frequency and an ending frequency for the set of frequency domain resources, a PTRS time domain resource pattern for the set of time domain resources, a PTRS frequency domain resource pattern for the set of frequency domain resources, a joint PTRS resource pattern for both the set of time domain resources and the set of frequency domain resources, or a combination thereof.

In a fifth aspect, alone or in combination with one or more of the first through fourth aspects, at least one of the set of time domain resources or the set of frequency domain resources are determined by a PTRS resource pattern, selected from multiple PTRS resource patterns corresponding to multiple MCSs, based at least in part on the MCS used for the RACH procedure.

In a sixth aspect, alone or in combination with one or more of the first through fifth aspects, the PTRS configuration depends on one or more demodulation reference signal (DMRS) configurations.

In a seventh aspect, alone or in combination with one or more of the first through sixth aspects, the one or more DMRS configurations include a downlink DMRS configuration, an uplink DMRS configuration, or both the downlink DMRS configuration and the uplink DMRS configuration.

In an eighth aspect, alone or in combination with one or more of the first through seventh aspects, an association between the one or more DMRS configurations and the PTRS configuration is indicated.

In a ninth aspect, alone or in combination with one or more of the first through eighth aspects, the PTRS configuration is included in RACH Msg2 that indicates a resource allocation for RACH Msg3.

In a tenth aspect, alone or in combination with one or more of the first through ninth aspects, the RACH Msg3 is descrambled using a temporary cell radio network temporary identifier (TC-RNTI), a random access radio network temporary identifier (RA-RNTI), or another type of radio network temporary identifier.

In an eleventh aspect, alone or in combination with one or more of the first through tenth aspects, performing the RACH procedure comprises receiving RACH MsgA with a PTRS, wherein the PTRS is generated using a Gold sequence and a scrambling identifier that is based at least in part on at least one of a radio network temporary identifier, a DMRS port number, or a preamble identifier indicated in RACH MsgA.

In a twelfth aspect, alone or in combination with one or more of the first through eleventh aspects, performing the RACH procedure comprises transmitting RACH MsgB with a PTRS, wherein the PTRS is scrambled using at least one of a radio network temporary identifier, a random access preamble identifier, or another user equipment (UE)-specific identifier.

In a thirteenth aspect, alone or in combination with one or more of the first through twelfth aspects, performing the RACH procedure comprises receiving RACH Msg1 or RACH MsgA with a RACH preamble that is generated using a Gold sequence.

In a fourteenth aspect, alone or in combination with one or more of the first through thirteenth aspects, the PTRS configuration indicates whether PTRS sequences are mapped to resource elements in a sequence-first, time-second manner or in a time-first, sequence-second manner.

In a fifteenth aspect, alone or in combination with one or more of the first through fourteenth aspects, a same PTRS configuration is used for an initial RACH transmission and a RACH retransmission.

In a sixteenth aspect, alone or in combination with one or more of the first through fifteenth aspects, an initial RACH transmission uses a first set of resources for PTRS transmission and a RACH retransmission uses a second set of resources for PTRS transmission that are different from the first set of resources, wherein the first set of resources and the second set of resources are indicated in the PTRS configuration using a set of PTRS resource patterns.

In a seventeenth aspect, alone or in combination with one or more of the first through sixteenth aspects, the RACH procedure is performed using a highest possible sub-carrier spacing supported by a UE capability and an uplink bandwidth part used for the RACH procedure.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
receiving a phase tracking reference signal (PTRS) configuration for a random access channel (RACH) procedure, wherein the PTRS configuration indicates a PTRS density per modulation and coding scheme (MCS); and
performing the RACH procedure according to the PTRS configuration and an MCS used for the RACH procedure.

2. The method of claim 1, wherein the PTRS configuration is included in at least one of system information, a physical broadcast channel communication, remaining system information, other system information, or a combination thereof.

3. The method of claim 1, wherein the PTRS configuration indicates whether PTRSs are enabled for the RACH procedure.

4. The method of claim 1, wherein the PTRS configuration indicates at least one of a set of time domain resources or a set of frequency domain resources for PTRS transmission.

5. The method of claim 4, wherein at least one of the set of time domain resources or the set of frequency domain resources are indicated using at least one of:
a starting symbol and an ending symbol for the set of time domain resources,
a starting frequency and an ending frequency for the set of frequency domain resources,
a PTRS time domain resource pattern for the set of time domain resources,
a PTRS frequency domain resource pattern for the set of frequency domain resources,
a joint PTRS resource pattern for both the set of time domain resources and the set of frequency domain resources, or
a combination thereof.

6. The method of claim 4, wherein at least one of the set of time domain resources or the set of frequency domain resources are determined by a PTRS resource pattern, selected from multiple PTRS resource patterns corresponding to multiple MCSs, based at least in part on the MCS used for the RACH procedure.

7. The method of claim 1, wherein the PTRS configuration depends on one or more demodulation reference signal (DMRS) configurations.

8. The method of claim 7, wherein the one or more DMRS configurations include a downlink DMRS configuration, an uplink DMRS configuration, or both the downlink DMRS configuration and the uplink DMRS configuration.

9. The method of claim 7, wherein the one or more DMRS configurations include a DMRS configuration corresponding to a RACH message for which the PTRS configuration is being determined.

10. The method of claim 1, wherein the PTRS configuration is included in RACH Msg2 that indicates a resource allocation for RACH Msg3.

11. The method of claim 10, wherein the RACH Msg3 is scrambled using a temporary cell radio network temporary identifier (TC-RNTI), a random access radio network temporary identifier (RA-RNTI), or another type of radio network temporary identifier.

12. The method of claim 1, wherein performing the RACH procedure comprises transmitting RACH MsgA with a PTRS, wherein the PTRS is generated using a Gold sequence and a scrambling identifier that is based at least in part on at least one of a radio network temporary identifier associated with the UE, a demodulation reference signal (DMRS) port number associated with the UE, or a preamble identifier indicated in RACH MsgA.

13. The method of claim 1, wherein performing the RACH procedure comprises receiving RACH MsgB with a PTRS, wherein the PTRS is scrambled using at least one of a radio network temporary identifier associated with the UE, a random access preamble identifier associated with the UE, or another UE-specific identifier.

14. The method of claim 1, wherein performing the RACH procedure comprises transmitting RACH Msg1 or RACH MsgA with a RACH preamble that is generated using a Gold sequence.

15. The method of claim 1, wherein the PTRS configuration indicates whether PTRS sequences are mapped to resource elements in a sequence-first, time-second manner or in a time-first, sequence-second manner.

16. The method of claim 1, wherein a same PTRS configuration is used for an initial RACH transmission and a RACH retransmission.

17. The method of claim 1, wherein an initial RACH transmission uses a first set of resources for PTRS transmission and a RACH retransmission uses a second set of resources for PTRS transmission that are different from the first set of resources, wherein the first set of resources and the second set of resources are indicated in the PTRS configuration using a set of PTRS resource patterns.

18. The method of claim 1, wherein the RACH procedure is performed using a highest possible sub-carrier spacing supported by a UE capability and an uplink bandwidth part used for the RACH procedure.

19. A method of wireless communication performed by a base station, comprising:
transmitting a phase tracking reference signal (PTRS) configuration for a random access channel (RACH) procedure, wherein the PTRS configuration indicates a PTRS density per modulation and coding scheme (MCS); and
performing the RACH procedure according to the PTRS configuration and an MCS used for the RACH procedure.

20. The method of claim 19, wherein the PTRS configuration indicates at least one of:
whether PTRSs are enabled for the RACH procedure,
a set of time domain resources for PTRS transmission,
a set of frequency domain resources for PTRS transmission, or
a combination thereof.

21. The method of claim 19, wherein the PTRS configuration depends on one or more demodulation reference signal (DMRS) configurations.

22. The method of claim 19, wherein the PTRS configuration is included in RACH Msg2 that indicates a resource allocation for RACH Msg3.

23. The method of claim 19, wherein performing the RACH procedure comprises receiving RACH MsgA with a PTRS, wherein the PTRS is generated using a Gold sequence and a scrambling identifier that is based at least in part on at least one of a radio network temporary identifier, a demodulation reference signal (DMRS) port number, or a preamble identifier indicated in RACH MsgA.

24. The method of claim 19, wherein performing the RACH procedure comprises transmitting RACH MsgB with a PTRS, wherein the PTRS is scrambled using at least one of a radio network temporary identifier, a random access preamble identifier, or another user equipment (UE)-specific identifier.

25. The method of claim 19, wherein performing the RACH procedure comprises receiving RACH Msg1 or RACH MsgA with a RACH preamble that is generated using a Gold sequence.

26. The method of claim 19, wherein the PTRS configuration indicates whether PTRS sequences are mapped to resource elements in a sequence-first, time-second manner or in a time-first, sequence-second manner.

27. The method of claim 19, wherein a same PTRS configuration is used for an initial RACH transmission and a RACH retransmission.

28. The method of claim 19, wherein an initial RACH transmission uses a first set of resources for PTRS transmission and a RACH retransmission uses a second set of resources for PTRS transmission that are different from the first set of resources, wherein the first set of resources and the second set of resources are indicated in the PTRS configuration using a set of PTRS resource patterns.

29. A user equipment (UE) for wireless communication, comprising:
a memory; and
one or more processors operatively coupled to the memory, the memory and the one or more processors configured to:
receive a phase tracking reference signal (PTRS) configuration for a random access channel (RACH) procedure, wherein the PTRS configuration indicates a PTRS density per modulation and coding scheme (MCS); and
perform the RACH procedure according to the PTRS configuration and an MCS used for the RACH procedure.

30. A base station for wireless communication, comprising:
a memory; and
one or more processors operatively coupled to the memory, the memory and the one or more processors configured to:
transmit a phase tracking reference signal (PTRS) configuration for a random access channel (RACH) procedure, wherein the PTRS configuration indicates a PTRS density per modulation and coding scheme (MCS); and
perform the RACH procedure according to the PTRS configuration and an MCS used for the RACH procedure.
